(19) United States
(12) Patent Application Publication
(10) Pub. No.: US 2020/0047372 A1
(43) Pub. Date: Feb. 13, 2020

(54) ARTIFICIAL STONE SLAB WITH INTEGRALLY FORMED PATTERN AND MANUFACTURING METHOD FOR THE SAME

(71) Applicant: MYEONG HWA CHUNG, SEOUL (KR)

(72) Inventor: MYEONG HWA CHUNG, SEOUL (KR)

(21) Appl. No.: 16/115,558

(22) Filed: Aug. 29, 2018

(30) Foreign Application Priority Data
Aug. 13, 2018 (KR) 10-2018-0094315

(51) Int. Cl. B28B 7/00; B28B 1/14; B28B 11/24

(52) U.S. Cl. CPC B28B 7/007; B28B 11/24; B28B 1/14

(57) ABSTRACT

An artificial stone slab with integrally formed patterns and its manufacturing method that enables integrally forming patterns of various complicated shapes and colors in an artificial stone slab. The artificial stone slab includes a mixture prepared by mixing raw materials for artificial stone in powder state and a plurality of the patterns having various shapes and attached to a sheet. The sheet with the patterns is set to the inner side of a rubber mold. The powdered mixture is added into the rubber mold to integrally form the patterns with the mixture. The underlying sheet is removed to form an artificial stone slab with the patterns. The patterns are exposed only on the topside of the artificial stone slab or on both top and bottom sides of the artificial stone slab.

### RELATED APPLICATION

This application claims priority from Korean Patent Application No. 10-2018-0094315 filed on Aug. 13, 2018, which is incorporated herein by reference in its entirety.

### FIELD OF THE INVENTION

The present invention relates to an artificial stone slab, and more particularly to an artificial stone slab with integrally formed patterns and a manufacturing method for the same that enables integrally forming patterns available in a wide variety of complicated shapes and colors.

### BACKGROUND OF THE INVENTION

Artificial stone is referred to as a synthetic stone product prepared by mixing natural stone powder or mineral with resin or cement and adding pigments and other additives to impart natural stone textures.

The artificial stone is currently used in a wide range of applications, due to its strength and color tones peculiar to finished products, elegant color tones as good as natural marble and differentiation from natural marble in the aspect of having higher strength and weather resistance and lower water absorption.

The artificial stones are no more than imitation stones intended to copy the surface pattern of natural granite or marble. In this respect, there has been no improvement in the artificial stones over thousands of years until today.

Recently, techniques have been proposed to fabricate an artificial stone with a pattern on the surface that makes it easier on the eyes.

For example, as illustrated in FIG. 1, a mix 4 of raw materials for artificial stone is poured into a mold 1 having a bottom 2 with a raised portion 3 or an engraved portion (not shown) so that a desired pattern is formed on the surface of the artificial stone, making the artificial stone easier on the eyes.

The artificial stone according to the prior art is, however, made to have a merely simple pattern on the surface rather than a delicate pattern of various shapes or colors more palatable to the customers. Furthermore, changing the pattern of the artificial stone entails the need of preparing a totally new mold for a new pattern, raising the production cost extremely high.

### SUMMARY OF THE INVENTION

For solving the problems with the prior art, it is an object of the present invention to provide an artificial stone slab with an integrally formed pattern and its manufacturing method that enables easily forming complicated patterns or characters of various shapes and colors more palatable to the customers rather than a simple pattern of natural stone.

It is another object of the present invention to provide an artificial stone slab with an integrally formed pattern and its manufacturing method that is designed to form a pattern going through the artificial stone slab, helping produce a neat and clean finish on the sides showing edges in the manufacture of the actual product.

It is further another object of the present invention to provide an artificial stone slab with an integrally formed pattern and its manufacturing method that enables a pattern to be integrally formed with the artificial stone slab without a separate adhesive or the like and thus causes no deformation in the boundaries of the pattern even in the case of a long-term use, securing high resistance to weather.

To achieve the objects of the present invention, there is provided an artificial stone slab with integrally formed patterns that includes a mixture prepared by mixing raw materials for artificial stone in powder state and a plurality of the patterns being prepared to have various shapes and attached to a sheet. The sheet with the plural patterns is set to the inner side of a rubber mold. The powdered mixture is added into the rubber mold to integrally form the patterns with the mixture. The underlying sheet is removed to form an artificial stone slab with the patterns. The patterns are exposed only on the topside of the artificial stone slab or on both top and bottom sides of the artificial stone slab by penetrating into the artificial stone slab from top to bottom.

There is also provided a method for manufacturing an artificial stone slab with integrally formed patterns that sequentially includes a pattern-making step (S10), a pattern-setting step (S20), a mixture-preparing step (S30), a mixture-dispensing step (S40), a vacuum-oscillation molding step (S50), a slab-releasing step (S60), a curing step (S70), a calibrating step (S80), and a polishing step (S90).

### EFFECTS OF THE INVENTION

The artificial stone slab with integrally formed patterns and its manufacturing method according to the present invention enables the formation of patterns of various complicated shapes and colors in artificial stone slabs and makes a great economic effect with large-quantity production achieved by integrally combining patterns with the mixture through a rubber mold.

Further, the artificial stone slab of the present invention involves integrally forming patterns with the mixture through a mold to create a natural form without a lack of harmony, thereby creating noticeably good effects of design, and contributes to the life extension of artificial stone slabs without a color change or dislocation of patterns, which results in easier maintenance.

Furthermore, the present invention realizes a firm combination of patterns and the mixture in an integral manner by simultaneously forming patterns and the mixture using a same material or a natural stone material, and thereby contributes to the life extension of artificial stone slabs without a color change or dislocation of patterns, resulting in easier maintenance.

In addition, when the patterns and the mixture are formed to have the same height, the patterns go through the artificial stone slab from top to bottom so that they are exposed on the top and bottom sides of the artificial stone slabs. This is applicable to any type of countertops, including those exposing their lateral edges, and enables a vertical, horizontal, or diagonal arrangement of exposed patterns in various ways, demonstrating groundbreaking effects on the market expansion in the same field.

### BRIEF DESCRIPTION OF THE DRAWINGS

FIG. 1 is a cross-sectional view showing a method for manufacturing an artificial stone according to prior art.

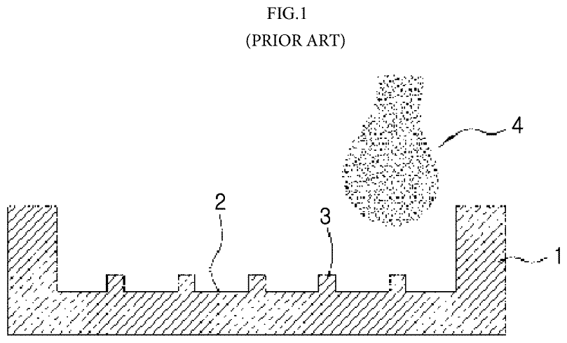

FIG. 2 is a block diagram showing a method for manufacturing an artificial stone slab according to the present invention.

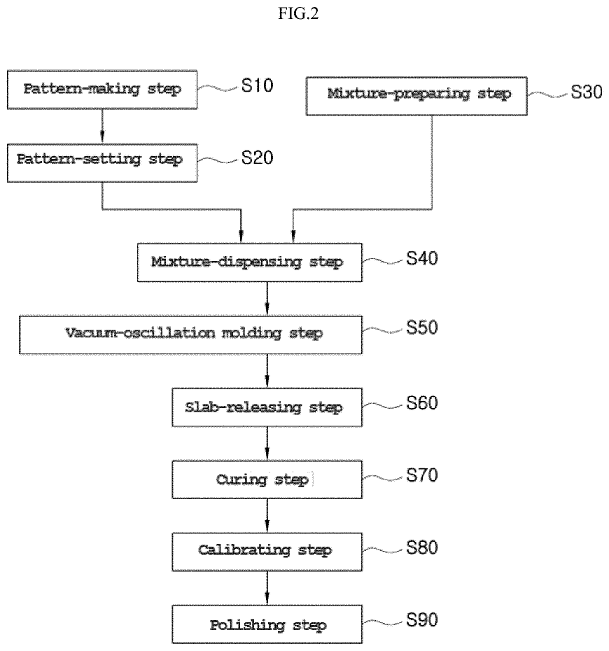

FIG. 3 is a perspective view showing that patterns are combined with a sheet according the present invention.

FIG. 4 is a perspective view showing that the sheet combined with patterns is set to the inner side of a rubber mold according to the present invention.

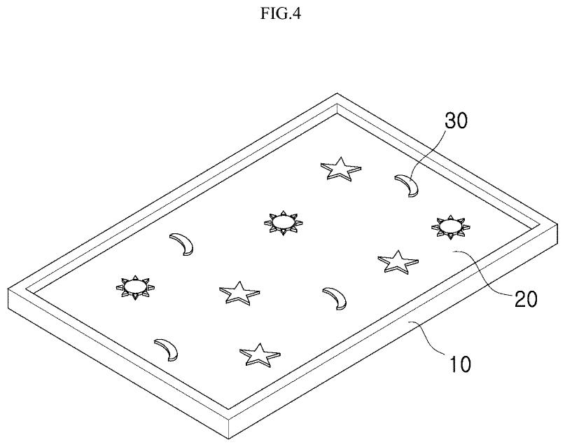

FIG. 5 is a cross-sectional view showing that a mixture is put into the rubber mold according to the present invention.

FIG. 6 is a cross-sectional view showing that the mixture settles down through a vacuum-oscillation process according to the present invention.

FIG. 7 is a cross-sectional view showing that a product is released from the rubber mold of FIG. 6.

FIG. 8 is a perspective view of an artificial stone slab with integrally formed patterns according to the present invention.

FIG. 9 is a cross-sectional view showing an artificial stone slab immediately after dispensing a mixture using a different material from that of patterns according to another embodiment of the present invention.

### DETAILED DESCRIPTION OF THE INVENTION

Hereinafter, the present invention will be described in further detail with reference to the preferred embodiments.

The artificial stone slab with integrally formed patterns according to the present invention is prepared by a method that sequentially includes a pattern-making step (S10), a pattern-setting step (S20), a mixture-preparing step (S30), a mixture-dispensing step (S40), a vacuum-oscillation molding step (S50), a slab-releasing step (S60), a curing step (S70), a calibrating step (S80), and a polishing step (S90).

In the pattern-making step S10, a pattern-making means including water-jet is used to prepare a plurality of patterns 30 having different shapes.

The pattern-making means may be realized by way of molding with various cutting tools capable of cutting solid-state materials, such as water-jet, laser processor, dice, etc., or a mold.

In one embodiment of the present invention, a solid made of the same material that forms a mixture 40 may be precisely processed into a desired pattern 30 by a water-jet that is a cutting machine using water pressure.

The patterns 30 are made up of at least one of symbol, character, figure, or color, which are alone or in combination. The patterns may come in different sizes and numbers to compose a text/character/logo/pattern, etc.

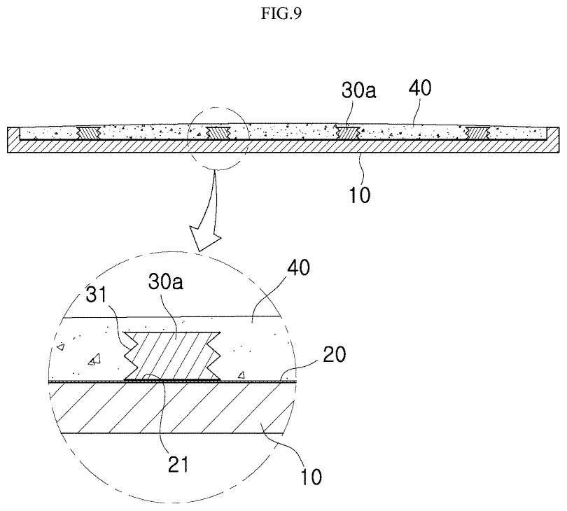

In another embodiment of the present invention, a pattern 30a may be formed with a solid made of a material different from the material forming the mixture 40, such as glass, metal, etc. Such a material different from the material forming the mixture 40 had a weak adhesion at the joining portions, so there is a need of an additional component for strengthening the adhesion, which will be described later with reference to FIG. 9.

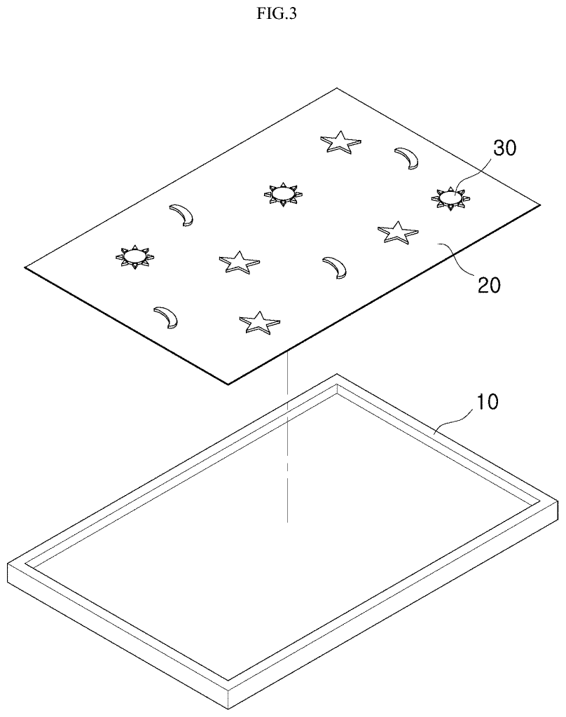

The pattern-setting step (S20) is fixing a plurality of patterns 30 on the topside of a sheet 20, as shown in FIG. 3.

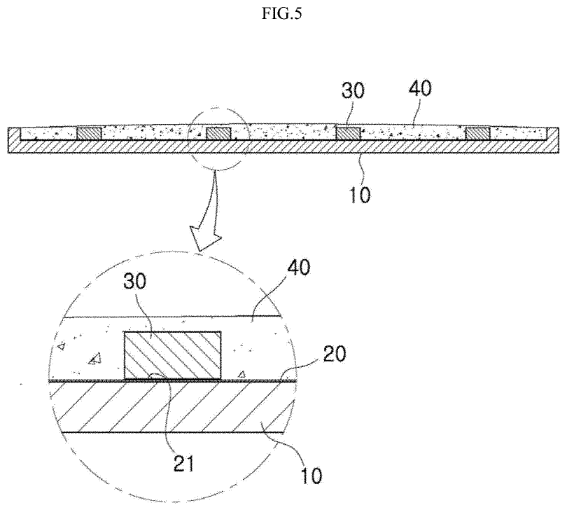

The sheet 20 is made of various materials, such as paper, synthetic resin, fabric, etc., and used to immobilize the patterns with an adhesive layer 21 comprised of an adhesive during the molding process, as shown in FIG. 5. In accordance with one embodiment of the present invention, the sheet 20 is preferably made of paper that can be easily separated from an artificial stone slab. The sheet 20 is removed in the calibrating step S80 after completion of the molding process.

The mixture-preparing step S30 is mixing raw materials of artificial stone at a predetermined mixing ratio in a mixer to prepare a mixture 40.

The mixture 40 is a composite of raw materials of artificial stone that consists of, according to one embodiment of the present invention, 90 wt. % of silica sand or quartz, 7 to 9 wt. % of polyester resin, and 1 to 3 wt. % of other chemicals. The components and the composition are well known in the related art and will not be further described.

The mixture-dispensing step S40 is setting the sheet 20 with fixed patterns 30 to the inner side of a rubber mold 10 and adding the mixture 40 from the top of the sheet 20.

In this regard, the mixture 40 is added as much as it covers the topside of the patterns 30; but in the following vacuum-oscillation molding step S50, it settles down to a height of the patterns 30.

In particular, the artificial stone slab of the present invention may realize not only a structure having the mixture 40 formed higher than the patterns 30 and exposing the patterns 30 on the one side solely, but also a structure having the mixture 40 and the patterns formed to the same height and exposing the patterns 30 on both sides. Forming either one of the structures is easily changeable by adjusting the depth of the rubber mold 10 in the making step or controlling the height of the patterns 30.

The present invention is constructed suitably for large-quantity production in such a manner that the mixture 40 is fed into the rubber molds 10 through a dispenser while a plurality of rubber molds 10 are being continuously transferred on a conveyor belt, which makes it possible to form a large quantity of artificial stone slabs for a minimum period of time with the production efficiency greatly raised about 50 times higher than the prior art.

Namely, in molding one artificial stone slab (3 m²) with patterns, for example, it takes about one hour in the prior art, but around 150 seconds according to the present invention.

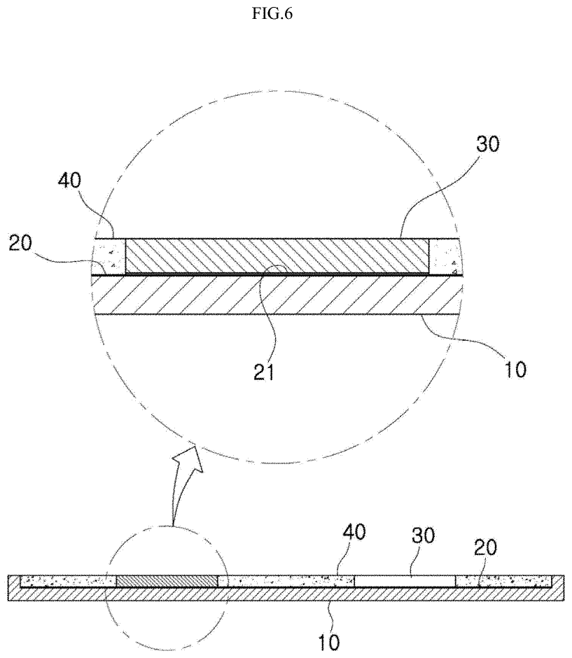

The vacuum-oscillation molding step (S50) is placing the rubber mold 10 in a vacuum chamber and applying oscillation to make the mixture 40 densely fill in the spaces between the patterns 30, forming an artificial stone slab 100 as shown in FIG. 6.

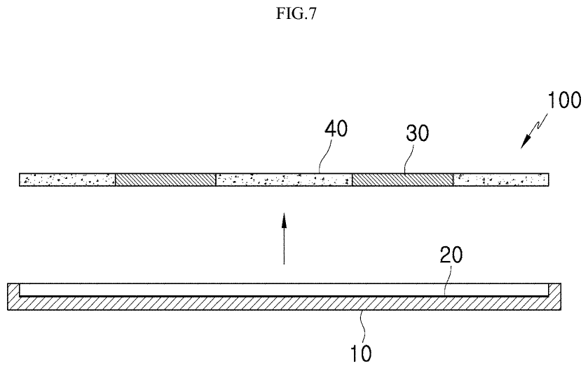

The slab-releasing step (S60) is separating the artificial stone slab 100 formed with the patterns 30 and the mixture 40 from the rubber mold 10, as illustrated in FIG. 7. The curing step (S70) is performing a curing process at 100 to 140° C. for 10 to 30 minutes in order to stabilize the resin contained in the separated artificial stone slab 100.

At this time, the rubber mold 10 is made of an elastic rubber material, so the completely molded artificial stone slab 100 can be easily withdrawn from the rubber mold 10.

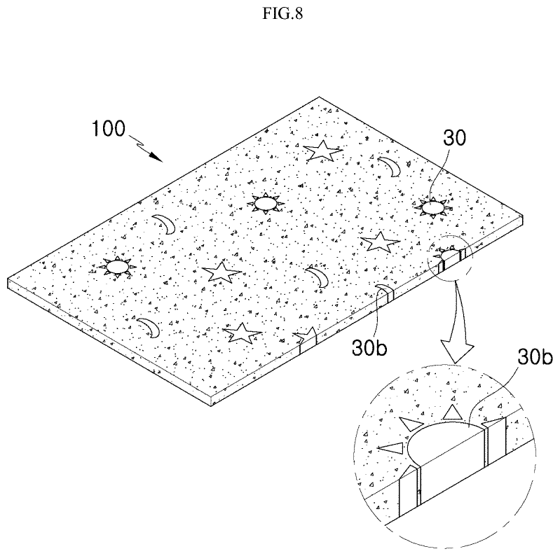

Subsequently, the calibrating step (S80) removes the underlying sheet 20 from the artificial stone slab 100. In the polishing step (S90), the projections on the top and bottom sides of the artificial stone slab 100 are removed with a grinder or the like to make the surface smooth, completing the artificial stone slab 100 with integrally formed patterns as shown in FIG. 8.

The artificial stone slab 100 of the present invention is manufactured in the standard size of at least 1000 mm×1800 mm×10 mm (length×depth×height) and the area per slab of 3 m² or greater, which standards may vary in obedience of an order.

In particular, the present invention involves positioning the patterns on the lateral edges of the sheet 20 in the pattern-setting step (S20), so the patterns are exposed directly on the lateral sides or edges of the completed artificial stone slab 100 as shown in the enlarged diagram of FIG. 8, which highlights the point of effective designs for all types of countertops exposing their lateral edges.

In the artificial stone slab 100 of the present invention, the patterns 30 made of the same material that forms the mixture 40 are firmly secured to the mixture 40 at the joining portions; while the patterns 30a made of a material different from the material forming the mixture 40 are often dislocated from the solidified mixture 40 by external shocks due to poor adhesiveness of the joining portions.

In this regard, the material different from the material forming the mixture 40 as used herein may include any type of raw materials different from the material of the pattern 30 including glass, metal, ceramic, natural marble, granite, and so forth.

In addition, the present invention provides another embodiment that includes a plurality of projections 31 formed on the lateral sides of the patterns 30a made of a material different from the material of the mixture 40.

Namely, as illustrated in FIG. 9, the sheet 20 with fixed patterns 30a made of a material different from the material that forms the mixture 40 is set in the rubber mold 10, and the mixture 40 is poured onto the sheet 20 as much as it covers the topside of the patterns 30a. Then, the vacuum-oscillation molding step (S50) is carried out to maintain the mixture 40 to a height (level) of the patterns 30a so that the patterns 30a are exposed on the top and bottom sides of the artificial stone slab 100 in the same manner as described with reference to FIG. 5. Due to the presence of the projections 31, the patterns 30a made of a material different from the material forming the mixture 40 are not dislocated by any external shock.

As described above, the artificial stone slab with integrally formed patterns and its manufacturing method according to the present invention enables the formation of patterns 30 and 30a available in a variety of complicated shapes and colors in the artificial stone slab 100 with ease and involves combining the patterns 30 and 30a with the mixture 40 through the rubber mold 10, so it is suitably available for large-quantity production to make a great economic effect.

Particularly, when the patterns 30 and 30a and the mixture are formed to have the same height, the patterns 30 and 30a go through the artificial stone slab 100 from top to bottom so that they are exposed on the top and bottom sides of the artificial stone slab 100, which is applicable to any type of countertops, including those exposing their lateral edges, and enables an effective exposure of pattern in a vertical, horizontal, or diagonal arrangement.

### REFERENCE NUMERALS

10: Rubber mold
20: Sheet
21: Adhesive layer
30, 30a: Patterns
31: Projections
40: Mixture
100: Artificial stone slab

What is claimed is:

1. An artificial stone slab with integrally formed patterns, the artificial stone slab comprising:
a powdered mixture prepared by mixing raw materials for artificial stone in a powder state;
a plurality of patterns comprising a plurality of shapes and attached to a sheet, the sheet with the plurality of patterns being set to an inner side of a rubber mold, the powdered mixture being added into the rubber mold with the sheet to integrally form the plurality of patterns with the powdered mixture, and the sheet removed to form the artificial stone slab with the integrally formed patterns;
wherein the plurality of patterns is exposed only on a top side of the artificial stone slab or on both top and bottom sides of the artificial stone slab upon penetration of the plurality patterns into the artificial stone slab from top to bottom.

2. The artificial stone slab with integrally formed patterns as claimed in claim 1, wherein the plurality of patterns is made of a same or different material from a material forming the powdered mixture.

3. The artificial stone slab with integrally formed patterns as claimed in claim 2, wherein the material of the plurality of patterns is different from the material forming the powdered mixture and comprises at least one selected from the group consisting of glass, metal, natural marble, granite, and ceramic; and wherein a plurality of projections formed on a lateral side of the plurality of patterns is made of a material different from the powdered mixture to prevent the plurality of patterns from being dislocated by a deterioration of a binding capacity.

4. A method for manufacturing an artificial stone slab with integrally formed patterns, sequentially comprising steps of:
preparing a plurality of patterns having various shapes through a pattern maker;
setting the plurality of patterns onto a top of a sheet;
mixing raw materials of artificial stone at a predetermined mixing ratio to prepare a mixture;
setting the sheet with the plurality of patterns to an inner side of a rubber mold and adding the mixture form a top of the rubber mold;
placing the rubber mold in a vacuum chamber and applying oscillation to mold the artificial stone slab with the mixture densely filling in spaces between the plurality of patterns;
separating the artificial stone slab molded with the plurality of patterns and the mixture from the rubber mold;
performing a curing process at a predetermined temperature in order to stabilize resins contained in the artificial stone slab separated from the rubber mold;
performing a calibrating process to remove the sheet underneath the artificial stone slab; and
performing a polishing process to remove projections on top and bottom sides of the artificial stone slab and to make surfaces of the artificial stone slab smooth.

5. The method as claimed in claim 4, wherein the curing process is performed at 100 to 140° C. for 10 to 30 minutes.

6. The method as claimed in claim 4, wherein the plurality of patterns comprises at least one of symbol, character, figure, or color alone or in combination thereof, the plurality of patterns comprises different sizes and numbers.
